(19) United States
(12) Patent Application Publication
(10) Pub. No.: US 2002/0183534 A1
(43) Pub. Date: Dec. 5, 2002

(54) Process for producing bismuth dithiocarbamates and dithiophosphorates

(76) Inventors: Robert Cisler, Clarendon Hills, IL (US); Hocine Faci, Batavia, IL (US); Shih-Ying Hsu, Chalfont, PA (US); Randall Krinker, Somonauk, IL (US); Curtis Lege, Doylestown, PA (US); Bill Pastore, Boothwyn, PA (US); Andrew Phillips, Lisle, IL (US)

Correspondence Address: NIXON & VANDERHYE P.C., 8th Floor, 1100 North Glebe Road, Arlington, VA, 22201, US

(21) Appl. No.: 10/138,524

(22) Filed: May 6, 2002

Related U.S. Application Data
(63) Continuation of application No. PCT/GB00/03909, filed on Oct. 12, 2000.

(30) Foreign Application Priority Data
Feb. 4, 2000 (GB) 0002524.7

(51) Int. Cl. C07F 9/94

(52) U.S. Cl. 556/18; 556/76

(57) ABSTRACT

A process for producing a bismuth dithiocarbamate or dithiophosphorate by the reaction of a bismuth hydroxide, bismuth oxide or bismuth oxynitrate with a dithiocarbamate or a dithiophosphoric acid. The bismuth dithiocarbamates and dithiophosphorates exhibit very good EP and antiwear properties and are useful in lubricant formulations.

The present invention concerns a process for producing oil-soluble bismuth dithiocarbamates and dithiophosphorates.

In the past, bismuth dithiocarbamates have been prepared by reacting bismuth halide such as bismuth trichloride with a dithiocarbamate. The reaction is a displacement reaction which produces hydrogen chloride as a by-product. One drawback of this reaction is that undesirable residues of chloride can remain in the product. These residues can be from partially reacted by-products, unreacted bismuth trihalide or metal halides generated in situ. Even small amounts of these residues are considered to be undesirable.

U.S. Pat. No. 5,631,214 discloses a process for producing bismuth dithiocarbamates using an exchange reaction between a bismuth carboxylate and a metal dithiocarbamate. Although the product produced in this reaction is not contaminated with a residue of chloride, it is contaminated with metal carboxylate (see lines 62-64 in column 2)

An aim of this invention is to provide an improved method for producing oil-soluble bismuth dithiocarbamates and dithiophosphorates.

A further aim of this invention is to provide a method for producing bismuth dithiocarbamates and dithiophosphorates in which the product is not contaminated with residues of chloride or metal carboxylate.

In accordance with the present invention there is provided a process for producing a bismuth dithiocarbamate or dithiophosphorate by the reaction of a bismuth hydroxide, bismuth oxide or bismuth oxynitrate with either a dithiocarbamate or dithiophosphoric acid.

In the reaction, water is produced as a by-product, which can be easily removed from the reaction.

The bismuth dithiocarbamate or dithiophosphorate produced in this process is free from the contaminants contained in the organometallic dithio-compounds produced by the prior art methods. The bismuth dithiocarbamate or dithiophosphorate produced by this process is also structurally different from the organometallic dithio-compounds produced in the above mentioned prior art methods.

The bismuth dithiocarbamate or dithiophosphorate produced in this process is a very good extreme pressure agent. It also exhibits very good anti-wear properties. These properties make the product useful and unique in lubricant formulations.

The bismuth oxide, bismuth hydroxide or bismuth oxynitrate may be represented by the following formulas: Bi₂O₃, Bi(OH)₃, or BiO(OH)₉(NO₃)₄ respectively.

The dithiocarbamate or dithiophosphorate used as the starting material in the process of the present invention is preferably prepared prior to use, freshly distilled or generated in situ.

A solvent can be used in the reaction, but is not essential. Suitable solvents are, for example, dimethyl sulfoxide, N,N-dimethylformamide, tetrahydrofuran, acetonitrile, benzonitrile, or commonly used polar or aprotic solvents, including any viscosity grade of paraffinic and naphthanic basestocks.

The preferred solvent is acetonitrile or a 100 SUS base oil.

The reaction is preferably conducted at a temperature between 50 to 200° C. The reaction is more preferably conducted at a temperature between 60 and 130° C.

The reaction is preferably conducted under pressure of 10-1000 psi of nitrogen, air or hydrogen sulfide. The most preferred pressure is between 60-250 psi of nitrogen.

The dithiocarbamate is preferably represented by the following formula:

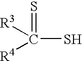

wherein R³ and R⁴ may be the same or different, or one of them is a H. R³ and R⁴ are preferably selected from the following groups: alkyl, alkenyl, cycloalkyl, cycloalkenyl, aryl, arylalkyl or hydrocarbyl groups, optionally incorporated with hetero atoms such as nitrogen, oxygen or sulfur atoms.

R³ and R⁴ are preferably represented by the following formula:

CH₃(CH₂)ₘ—X—(CH₂)ₙ—

wherein: m is 1-30, preferably 1-20, and n ranges from 1-10, preferably from 1-5. X can be oxygen, nitrogen or sulfur.

When bismuth oxide, hydroxide or oxynitrate is reacted with dithiocarbamate (commonly referred to as ‘DTC’) in accordance with the present invention, the product can be represented by the following formula:

Bi(OH)ₓ(DTC)_{y}(NO₃)₂

wherein x+y+z=3, and z is zero when the bismuth oxide or hydroxide is used as one of the starting materials.

The dithiophosphoric acid is preferably represented by the following formula:

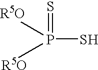

wherein R⁵ is a hydrocarbyl group having a carbon chain length of 1-20, preferably of 1-10. The dithiophosphoric acid can be prepared by reaction of the an alcohol having the R⁵ group with a phosphorous pentasulfide, which is well-known to persons skilled in the art. The reaction temperature and time for the reaction of the bismuth oxide, hydroxide or oxynitrate with the dithiophosphoric acid are the same as mentioned above for the reaction of the bismuth hydroxide or oxide with the dithiocarbamate.

The bismuth dithiophosphorate produced in accordance with the present invention is preferably represented by the following general formula:

Bi(OH)ₘ(DTP)ₙ(NO₃)ₒ

wherein m+n+o=3, and o is zero when Bi₂O₃ or Bi(OH)₃ is used in the process.

The product may appear as a brown-red oil or a yellow solid which is very soluble in non-polar solvents such as pentane or hexane. The product exhibits excellent solubility in paraffinic or naphthanic base stocks.

The bismuth dithiocarbamates and dithiophosphorates produced in the process of the present invention exhibit load-carrying and antiwear characteristics. The bismuth dithiocarbamates and dithiophosphorates may, for example, be incorporated into a standard grease formulation.

The present invention will now be described, by way of example only, with reference to the following examples:

### EXAMPLE 1

### Preparation of Bismuth (III) Diamyldithiocarbamate Using Bismuth Oxide

A suspension of bismuth (III) oxide (9.2 g, 0.0198 mol) and diamyldithiocarbamate (27.9 g, 0.119 mol) was prepared in acetonitrile (200 ml). The suspension was brought to reflux and then maintained at that temperature for 5 hours. A brown suspension was produced. The brown suspension was filtered, and the solvent was evaporated under reduced pressure to produce a viscous brown liquid (13.0 g).

### EXAMPLE 2

### Preparation of Bismuth (III) Dioctyldithiocarbamate Using Bismuth Oxide

A suspension of bismuth (III) oxide (34.3 g, 0.0736 mol) and di-n-octylamine (106 g, 0.4416 mol) was prepared in acetonitrile (200 ml). The suspension was cooled to 15° C., followed by a slow addition of carbon disulfide (27 ml, 0.4416 mol) over a 30 minute period. The mixture was then refluxed for 5 hours during which the colour of the mixture changed from yellow to a brownish colour. The resultant mixture was filtered and the solvent was evaporated under reduced pressure to produce a viscous brown oil (120 g).

### EXAMPLE 3

### Preparation of Bismuth (III) Diamyldithiocarbamate Using Bismuth Oxynitrate

A suspension of bismuth (III) oxynitrate (20.5 g, 0.0789 mol) and diamylamine (37.2 g, 0.2367 mol) was prepared in acetonitrile (200 ml). Carbon disulfide (15 ml, 0.2367 mol) was slowly added at ambient temperature. A slight exotherm occurred which took the reaction temperature up by 10° C. A yellow mixture was produced which was refluxed for 5 hours to produce a brown liquid. The brown liquid was filtered and the solvent was evaporated to produce a brown liquid (40 g).

### EXAMPLE 4

### Preparation of Bismuth (III) Diisononyldithiocarbamate Using Bismuth Oxynitrate

A suspension of bismuth (III) oxynitrate (24.4 g, 0.0936 mol) and diisononylamine (75.5 g, 0.2808 mol) was prepared in acetonitrile (200 ml). Carbon disulfide (17 ml, 0.2367 mol) was added slowly at ambient temperature. A slight exotherm took place on addition of the carbon disulfide which brought the temperature up by 10° C. A yellow mixture was produced which was refluxed for 5 hours. After filtration and solvent removal, the product produced was a brown paste (47 g). Further purification was conducted by dissolving the brown paste in hexane (300 ml), followed by cooling at 40° F. overnight to effect recrystallization and produce a bright yellow solid.

### EXAMPLE 5

### Preparation of Bismuth (III) 2-Ethylhexyldithiophosphorate Using Bismuth Hydroxide

A suspension of bismuth (III) hydroxide (27.0 g, 0.1036 mol) and 2,6di-t-butyl-4-methyl phenol (BHT, 500 mg) was prepared in acetonitrile (200 ml). 2-ethylhexyldithiophosphoric acid (109 g, 0.3108 mol) was added over a 15 minute period. The resultant suspension was heated under reflux for 8 hours to produce a yellow liquid. The yellow liquid was filtered and the solvent was evaporated under reduced pressure to produce a reddish oil (131 g).

The performance of the bismuth dithiocarbamate and bismuth dithiophosphorate prepared above in Examples 3 and 5 respectively were compared to a commercial EP additive. The results are given below:

| | | | Grease with | Grease with |
|---|---|---|---|---|
| | | Grease with | BiDADTC | BiDIODTP |
| | ASTM | Commercial | prepared in | prepared in |
| TEST | METHOD | EP Additive | Example 3 | Example 5 |
| Four-ball EP | D-2596 | 400 | 500 | 400 |
| Weld Load, | | | | |
| Kg | | | | |
| Four-ball | D2265 | 0.54 | 0.83 | 0.51 |
| Wear | | | | |
| mm Scar | | | | |

The grease used in the above test was lithium 12-hydroxystearate. The commercial EP additive was antimony dithiocarbamate.

As shown above, the oil-soluble bismuth dithiocarbamate prepared in Example 3 exhibited better EP results than the commercial EP additive.

As also shown above, the bismuth dithiophosphorate prepared in Example 5 exhibited better wear results than the commercial EP additive.

The oil-soluble bismuth dithiophosphorates produced in the above Examples also exhibited an improved reduction in the coefficient of friction and enhanced thermo-oxidative stability.

1. A process for producing a bismuth dithiocarbamate or dithiophosphorate by the reaction of bismuth hydroxide, bismuth oxide or bismuth oxynitrate with a dithiocarbamate or dithiophosphoric acid.

2. The process claimed in claim 1, wherein the bismuth oxide, bismuth hydroxide or bismuth oxynitrate is represented by the following formulas: Bi₂O₃, Bi(OH)₃, or BiO(OH)₉(NO₃)₄ respectively.

3. The process claimed in claims 1 or 2, wherein a solvent is not used in the process.

4. The process claimed in claim 3, wherein the solvent is selected from: dimethyl sulfoxide, N,N-dimethylformamide, tetrahydrofuran, acetonitrile, benzonitrile, or commonly used polar or aprotic solvents including paraffinic and naphthanic basestocks.

5. The process claimed in claims 3 or 4, wherein the solvent is acetonitrile or a 100 SUS base oil.

6. The process claimed in any one of the preceding claims, wherein the reaction is conducted at a temperature between 50 to 200° C., preferably at a temperature between 60 and 130° C.

7. The process claimed in any one of the preceding claims, wherein the reaction is conducted under pressure between 10-1000 psi of nitrogen, air or hydrogen sulfide; preferably 6-250 psi of nitrogen.

8. The process claimed in any one of the preceding claims, wherein the dithiophosphoric acid is represented by the following formula: 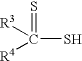
wherein R³ and R⁴ may be the same or different, and only one of them is a H;
R³ and R⁴ are selected from the following groups: alkyl, alkenyl, cycloalkyl, cycloalkenyl, aryl, arylalkyl or hydrocarbyl groups, optionally with hetero atoms such as nitrogen or oxygen atoms; and
R³ and R⁴ are preferably represented by the following formula:
CH₃(CH₂)ₘ—X—(CH₂)ₙ—
wherein: m is 1-30, preferably 1-20, and n ranges from 1-10, preferably from 1-5. X can be oxygen or nitrogen.

9. The process claimed in any one of the preceding claims, wherein the process produces a bismuth dithiocarbamate represented by the following formula:
Bi(OH)ₓ(DTC)_{y}(NO₃)_{z}
wherein x+y+z=3, and z is zero when the bismuth oxide or hydroxide is represented by Bi₂O₃ or Bi(OH)₃.

10. The process claimed in any one of the preceding claims, wherein the dithiophosphoric acid is represented by the following formula: 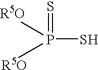
wherein R⁵ is a hydrocarbyl group having a carbon chain length of 1-20, preferably of 1-10.

11. The process claimed in claim 10, wherein the process produces a bismuth dithiophosphorate represented by the following general formula:
Bi(OH)ₘ(DTP)ₙ(NO₃)ₒ
wherein m+n+o=3, and o is zero when Bi₂O₃ or Bi(OH)₃ is used.

12. Use of the bismuth dithiocarbamate or dithiophosphorate produced by any one of the processes claimed in claims 1-11, as an extreme pressure agent and/or an antiwear agent.

13. A lubricant or a grease comprising the bismuth dithiocarbamate or dithiophosphorate produced in any one of claims 1-11.

14. A bismuth dithiocarbamate represented by the following general formula:
Bi(OH)ₓ(DTC)_{y}(NO₃)_{z}
wherein x+y+z=3.

15. A bismuth dithiophosphorate represented by the following general formula:
Bi(OH)ₘ(DTP)ₙ(NO₃)ₒ
wherein m+n+o=3.
